(19) United States
(12) Patent Application Publication
(10) Pub. No.: US 2011/0289489 A1
(43) Pub. Date: Nov. 24, 2011

(54) CONCURRENT CROSS BROWSER TESTING

(75) Inventors: Balaji Kumar, Irving, TX (US); Kamal Abou-Khamis, Richardson, TX (US); Venkadaraman Balasubramanian, Chennai (IN); Praveenkumar Subramanian, Chennai (IN); Manikandan Subramanian, Salem (IN)

(73) Assignee: Verizon Patent and Licensing Inc., Basking Ridge, NJ (US)

(21) Appl. No.: 12/784,042

(22) Filed: May 20, 2010

(51) Int. Cl. G06F 9/44

(52) U.S. Cl. 717/135

(57) ABSTRACT

A system may include a plurality of test environments, each test environment being configured to simulate user actions according to a test configuration. The system may further include a test simulator device including a processor in selective communication with the plurality of test environments and configured to receive a user action; send the user action to a first of the plurality of test environments having a first test environment; and send the user action to a second of the plurality of test environments having a second test environment.

### BACKGROUND

Web pages are becoming an increasingly popular platform for application development. At the same time, the types of software that clients utilize to access web applications are becoming more diverse. Users may utilize many types and versions of software clients to access web applications, including various web browsers, browser plug-ins, and operating systems. Additionally, clients may use these types and versions in different combinations. Thus, with the large array of possible client configurations, certification of web applications for cross compatibility is becoming a mammoth task, requiring significant testing effort.

### BRIEF DESCRIPTION OF THE DRAWINGS

FIG. 1 illustrates an exemplary system for the recording and simulation of test cases against an application under test.

FIG. 2 illustrates an exemplary test case for an initial setup of an application under test.

FIG. 3 illustrates an exemplary test case for the testing of a portion of functionality of an application under test.

FIG. 4 illustrates an exemplary user interface for the mapping of logical names to user actions of a selected test case.

FIG. 5 illustrates an exemplary user interface for the selection of test cases for simulation by a simulator.

FIG. 6 illustrate an exemplary user interface for the selection of user actions for simulation by a simulator.

FIG. 7 illustrates an exemplary system view of the execution of a single user action sent from a simulator to multiple test environments.

FIG. 8 illustrates an exemplary system view of the logging of an executed single user action by multiple test environments.

FIG. 9 illustrates an exemplary log file.

FIG. 10 illustrates an exemplary user interface for the analysis of a failure in a log file.

FIG. 11 illustrates an exemplary process for the creation of test cases.

FIG. 12 illustrates an exemplary process for the mapping of logical names to user actions of a stored test case.

FIG. 13 illustrates an exemplary process for the execution of test cases.

### DETAILED DESCRIPTION

An application under test may require verification on multiple supported environments before the application may be released to users. Verification may be required for introduction of a new application, for a new release of an existing application, or even for even a minor fix or other change in functionality. While testing the change in a single environment may be relatively easy to accomplish, a manual testing effort to validate functionality for multiple environments may impose a significant testing effort on a quality assurance team.

Although various automation tools are available in the market, many of these tools support only a small subset of supported environments, such as only limited browser versions. Additionally, many existing automation tools require major modifications to recorded test cases in order to facilitate testing in an environment other than the one in which the test was recorded. Some automation tools also require internal aspects of a corporate network to be exposed to outside computing devices, which may be against corporate security guidelines and difficult to work around. Accordingly, even when utilizing test automation, a significant effort by the quality assurance team may still be required when performing compatibility testing of an updated version of an application.

A testing solution may provide a framework in which a set of compatibility test cases may be recorded once against an application under test and stored in a simple format in a common repository. Each compatibility test case may include a set of user actions that indicate the actions that the user performed against the application under test, such as a mouse clicks or text entered into fields. To facilitate understanding of the test case to non-technical users, logical names describing the function of the user actions may be assigned. These user actions may be selected and simulated on the application under test, and compared against an expected result. Based on these comparisons, the functionality of the application under test may be verified.

Execution of the compatibility test cases may be managed from the testing solution by a utility, where the utility may receive the selection of one or more test cases to run along with a plurality of test environments in which to run them. The test environments may include different combinations of supported browsers, operating systems, and plug-in versions. The utility then may pick the user actions stored in the common repository for the selected test cases, and simulate the user actions in the selected test environments. The test cases may be simulated on the same or different test environments from where they were recorded, on either the same device or another device on the network. Accordingly, the captured user actions may be simulated in the application under test across multiple devices having varying environments, including different combinations of supported browsers, operating systems, and plug-in versions, without modification of the test case itself.

The testing solution may allow for the captured user actions to be selected for simulation at a test case or at a user action level of granularity, providing users with granular execution control at both the test case and the user action levels. The testing solution may further provide for the user actions and test cases to be simulated across various browsers and operating systems substantially in parallel, facilitating easy analysis of any compatibility issues.

The testing solution may additionally provide for the selective re-use of server sessions and web browsers, allowing for custom test case ordering without repeated login and logout actions. Such a testing solution may therefore be utilized to efficiently simulate compatibility situations, and may be suitably extendible for smoke testing and sanity testing scenarios.

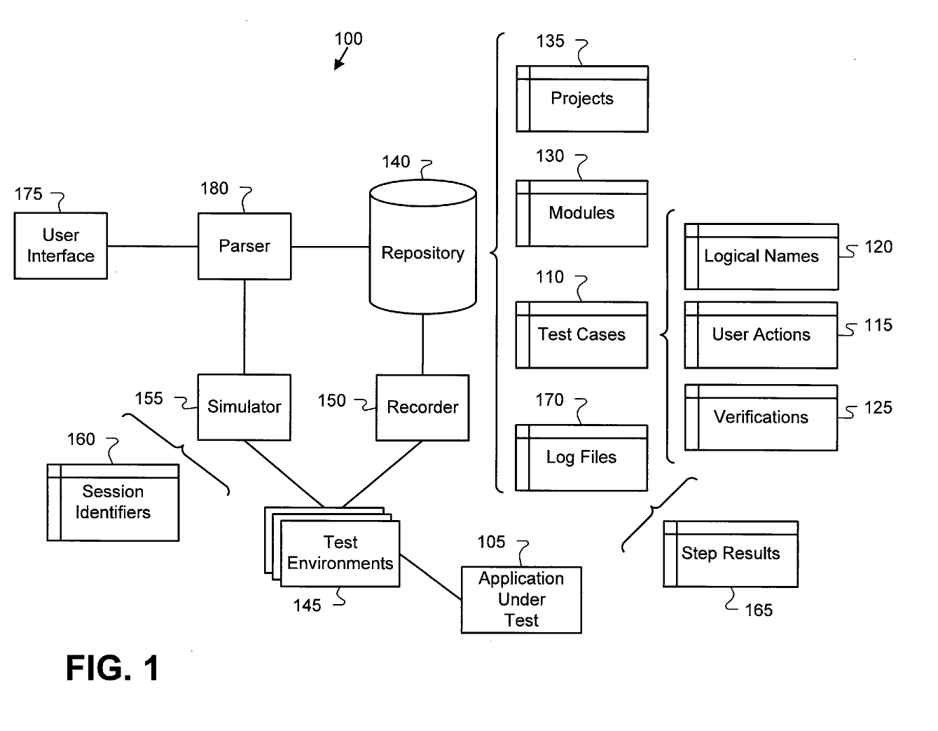

FIG. 1 illustrates an exemplary system 100 including an application under test 105 upon which test cases 110 may be performed. The test cases 110 may include user actions 115, logical names 120 assigned to the user actions 115, and verifications 125. The system 100 may further include a repository 140 configured to store projects 135 and the test cases 110 organized by module 130. The system 100 may also include a plurality of test environments 145 under which the application under test 105 may be executed, a recorder 150 configured to record test cases 110 from at least a portion of the test environments 145, and a simulator 155 configured to simulate test cases 110 in at least a portion of the test environments 145. The repository 140 may further be configured to store step results 165 in log files 170, the step results 165 being based on the simulation of the test cases 110 by the simulator 155. The system 100 may further include a user interface 175 and a parser 180 configured to allow for management and control of the system 100. System 100 may take many different forms and include multiple and/or alternate components and facilities. While an exemplary system 100 is shown in FIG. 1, the exemplary components illustrated in Figure are 1 not intended to be limiting. Indeed, additional or alternative components and/or implementations may be used.

An application under test 105 may be a software application that is the subject of a testing effort. A test case 110 may include one or more steps directed toward a portion of application functionality of the application under test 105. The steps of a test case 110 may be played back, or simulated, against the application under test 105. Based on the simulation, the test case 110 may be used to determine whether a portion of the functionality of the application under test 105 is functioning as designed.

The steps of the test case 110 may include one or more user actions 115. Each user action 115 may accordingly represent a discrete user input actions to be performed on the application under test 105. Examples of user actions 115 may include: clicking on a button, entering text into a field, deleting or clearing text out of a field, selecting or deselecting a checkbox, selecting an item from a dropdown list, scrolling all or a part of a view, and navigating to another page of an application, among others. User actions 115 may be combined together to accomplish larger tasks, such as logging into an application or navigating among various pages of an application.

Because the code used to perform the user actions 115 may not be very user-friendly, logical names 120 may be associated with the user actions 115 to provide a more easy-to-understand representation of the step being performed by the user action 115 code. A logical name 120 may be an arbitrary word or phrase associated with a user action 115, and may be entered by a user for each user action 115 to explain the purpose or effect of the associated user action 115. Then the logical names 120 may be displayed to provide a more easy-to-understand version of the test case 110 instead of displaying the underlying code of the user actions 115.

In some instances, a test case 110 that runs to completion without errors may be considered to be a passed test, while in other instances, a test case 110 may include one or more verifications 125 that may be used to determine whether a particular test passes or fails. Verifications 125 may represent a specific portion of application functionality to verify, and may be utilized to determine the current state of the application under test 105. Verifications 125 may thus be used to verify that various functionality of the application under test 105 is functioning as designed. As some examples, a verification 125 may ensure that the title of a page is correct, that a result of a mathematical computation appearing in an application field is properly calculated, or that proper controls or fields appear in their intended locations in the user interface of the application under test 105.

The test cases 110 may be stored in a repository 140. The repository 140 may include one or more data storage mediums, devices, or configurations, and may employ various types, forms, and/or combinations of storage media, including but not limited to hard disk drives, flash drives, read-only memory, and random access memory. The repository 140 may include various technologies useful for storing and accessing any suitable type or form of electronic data, which may be referred to as content. Content may include computer-readable data in any form, including, but not limited to video, image, text, document, audio, audiovisual, metadata, and other types of files or data. Content may be stored in a relational format, such as via a relational database management system (RDBMS). As another example, content may be stored in a hierarchical or flat file system.

The repository 140 may be configured to selectively store and retrieve a plurality of test cases 110. In some examples, each test case 110 may be stored as an individual record in the test repository 140. Each user action 115 may also be stored as an individual record associated with the test case 110 in the repository 140. As an additional level of organization of the test cases 110, the test cases 110 may be organized into modules 130, where each module 130 including test cases 110 associated with a particular portion of functionality or with a particular application under test 105.

Additionally, modules 130 may further be organized into projects 135, where each project 135 may be associated with a collection of one or more modules 130. A project 135 may be named according to an application under test 105 to which it refers. In some instances, a project 135 may include or otherwise be associated with one or more a universal resource locators (URL) for particular versions of the application under test 105. These URLs for the particular versions of the application under test 105 may be referred to as a base URLs. The base URL may indicate a location at which to being the testing of an application under test 105, such as a main page or a login page of an application under test 105. As an example, a first project 135 may include a base URL for a production version of the application under test 105 (e.g., http://www.example.com), a base URL for a system testing or an integration testing version of the application under test 105 (e.g., http://www.2.example.com), and/or a base URL for a development version of the application under test 105 (e.g., http://www.3.example.com).

The repository 140 may be configured to receive queries for individual test cases 110, and to respond by returning the queried test cases 110. The repository 140 may further be configured to receive a query for a listing of the available test cases 110 (such as the available test cases 110 within a module 130), and to respond with a list of the available test cases 110. The repository 140 may further be configured to receive new test cases 110 for storage and later retrieval. Further details regarding the exemplary data elements that may be stored in the repository 140 are discussed in further detail below.

A test environment 145 may include hardware and supporting software required for the execution of an application under test 105. A test environment 145 may be a standalone computing device, such as a personal computer, or may be a virtualized instance of a computing device created by way of a virtualization software package. Accordingly, test environments 145 may be implemented as a combination of hardware and software, and may include one or more software applications or processes for causing one or more computer processors to perform the operations of the test environment 145 described herein.

The system 100 may include test environments 145 having various hardware and software configurations. A plurality of different test environments 145 may be included in the testing system 100, allowing for different configurations of the test environment 145 to be available for the testing of an application under test 105. As some examples, test environments 145 may be included having different hardware characteristics, such as processor speed, processor type, and available hardware devices, and having different software characteristics, such as installed operating systems and installed software packages. Each test environment 145 may be labeled according to its included configuration, thus allowing the appropriate test environments 145 to be easily identified for inclusion in a compatibility test. Each test environment 145 may also be associated with a hostname or other network identifier, such as an Internet Protocol (IP) address, to facilitate identification and communication with the test environments 145 of the system.

As a specific example, each test environment 145 in a web compatibility testing system 100 may include a unique combination of a web browser and an operating system on which the browser may run. Thus, a plurality of test environments 145 may be included that have different installed versions of browsers and operating systems to facilitate compatibility testing of an application under test 105 in different web application scenarios.

An operating system, such as the operating system installed in a test environment 145, may include software that works as interface for device hardware and makes an abstraction of the device hardware available to other software executing on the device. The operating system may be responsible for the management and coordination of processes, for the sharing of the resources of hardware, and to act as a host for computing applications running on the operating system. Exemplary operating systems may include versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system.

A browser, such as the browser installed in a test environment 145, may be a software application hosted on the operating system. The browser may be configured to retrieve, present, and navigate accessible information resources. More specifically, the browser may be configured to access information resources provided by Web servers on private networks or intranets, information resources available as files within an accessible file system, or information resources available over the Internet or another wide-area network. Exemplary browsers may include those using the Trident layout engine such as Microsoft® Internet Explorer™, those using the Presto layout engine such as the Opera® web browser, those using the Gecko™ layout engine such as the Firefox® web browser and the K-Meleon™ web browser, and those using the WebKit™ layout engine such as the Google® Chrome™ web browser and the Apple® Safari® web browser.

Each browser may in turn host or otherwise depend on additional functionality that may affect the test environment 145. For example, a test environment 145 may optionally include one or more of a Java® plug-in and a Flash® plug-in.

A recorder 150 may be in selective communication with at least a portion of the test environments 145 and may be configured to record test cases 110 from the test environments 145 with which it is in communication. As an example, the recorder 150 may be configured to record user actions 115 performed by a user in a particular web browser. Because test cases 110 that are recorded may be simulated in a variety of test environments 145, it may not be necessary for the recorder 150 to support the recording of user actions 115 within each of the available test environments 145. The recorder 150 may be further configured to send the recorded test cases 110 to the repository 140 for storage.

A simulator 155 may be configured to simulate user actions 115 (such as those recorded by the recorder 150) as well as any verifications 125 specified by the test cases 110. The simulator 155 may receive one or more messages including the test cases 110 or user actions 115 to simulate or indicating test cases 110 or user actions 115 to retrieve from the repository 140 for simulation. To perform the simulation, the simulator 155 may include a controller portion outside the test environment 145, and an agent part inside of the test environment 145. The controller may send user actions 115 to the agent, and the agent may execute the user actions 115 against the application under test 105.

The agent may return step results 165 based on the status of execution of the user action 115, and the controller may receive the step results 165. These step results 165 may indicate the result of the simulated user actions 115 and verifications 125. The simulator 155 may further send the step results 165 to the repository 140 for storage in log files 170. In some instances, the step results 165 include a screen capture of the application under test 105 after the execution of each associated user action 115.

For example, the simulator 155 may enter text into a field according to a user action 115 indicating that text was entered into a field and may indicate in a step result 165 whether the field was located and the text was entered. As another example, the simulator 155 may click a button that was indicated as being clicked by a user action 115 and may then take a screenshot of the application after clicking the button. In some instances, to conserve system resources, a screenshot may only be captured if the user action 115 was not completed successfully. As yet another example, the simulator 155 may perform an interface verification 125 or a base URL verification 125 against the application under test 105.

The simulator 155 may be configured to simulate the same test case 110 or user actions 115 in multiple test environments 145 at substantially the same time. For example, the controller portion of the simulator 155 may send a first user action 115 to a plurality of test environments 145, and may wait for a response from each of the plurality of test environments 145 indicating the status of simulation of the first usage action 115. Once a step result 165 is received from each test environment 145 for the simulation of the first user action 115, a second user action 115 may then be sent to each of the test environments 145.

In some examples, the simulator 155 may further be configured to launch the test environments 145 by sending launch commands to a network identifier associated with the requested test environments 145, and receive session identifiers 160 indicative of the launched test environments 145. The simulator 155 may further be configured to run test cases 110 or user actions 115 in the test environments 145 by specifying the requested test environments 145 by session identifier 160 and network identifier. The simulator 155 may further allow for selective reuse of the test environments 145 for multiple test cases 110 by continued use of the same session identifiers 160 and network identifiers. For example, with regard to a web test environment 145, rather than launch a new browser for each test case 110, the simulator 155 may be configured to reuse an existing browser session previously opened in the test environment 145 by a preceding test case 110. This session to be reused may accordingly be specified by session identifier 160 and/or by a hostname or other network identifier associated with the test environment 145.

The user interface 175 may be configured to allow for management and control of the system 100 by a user, and the parser 180 may perform portions of the back-end functionality exposed to the user by way of the user interface 175. For example, the user interface 175 may be configured to allow a user to initiate the recording of one or more test cases 110 by the recorder 150. The user interface 175 may further be configured to facilitate the importing of existing test cases 110 via the parser 180, and for the saving of imported or recorded test cases 110 into the repository 140. The user interface 175 may also be configured to allow for a user to control the parser 180 to enter logical names 120 for user actions 115, and to edit existing test cases 110 and user actions 115. The user interface may further be configured to allow the user to select one or more test cases 110 or user actions 115 for simulation by the simulator 155 and one or more test environments 145 into which to simulate the test cases 110. Further details of the user interface 175 are discussed below.

As an example, the parser 180 may further provide for receiving assigned logical names 120 from the user interface 175, and for communicating with the repository 140 in order to assign the of logical names 120 to user actions 115 records in the repository 140. As some other examples, the parser 180 may provide for communication between the user interface 175 and the repository 140 to allow for renaming, editing, importing, and deletion of test cases 110. Additionally, the parser 180 may allow for the splitting of multiple test cases 110 recorded in one session by the recorder 150 into a set of logical test cases 110.

In general, computing systems and/or devices, such as the one or more computing devices configured to implement the aforementioned repository 140, recorder 150, simulator 155, parser 180, and user interface 175, may employ any of a number of computer operating systems, including, but by no means limited to, the operating systems discussed above. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java®, C, C++, Visual Basic®, Java Script, Perl™, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The repository 140, recorder 150, simulator 155, parser 180, and user interface 175 may be provided as software instructions that when executed by at least one processing device provide the operations described herein. Alternatively the repository 140, recorder 150, simulator 155, parser 180, and user interface 175 may be provided as hardware or firmware, or combinations of software, hardware and/or firmware.

Databases, repositories or other data stores described herein, such as repository 140, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

Although one example of the modularization of the system 100 is illustrated and described, it should be understood that the operations thereof may be provided by fewer, greater, or differently named modules. For example, at least a portion of the simulator 155, recorder 150, parser 180 may be combined into a single module. As another example, the repository 140 may include a plurality of databases that each includes a subset of the data, such as one database for test cases 110 and a second database for log files 170.

A testing effort may include test cases 110 designed for a smoke test which evaluates a daily software build to determine its relative stability, and test cases 110 designed for a sanity test which performs a brief run-through of the functionality of a computer program to verify that the system works as expected prior to more detailed tests. A testing effort may further include compatibility test cases 110, where the same test cases 110 are run for the application under test 105 within different testing environments 145.

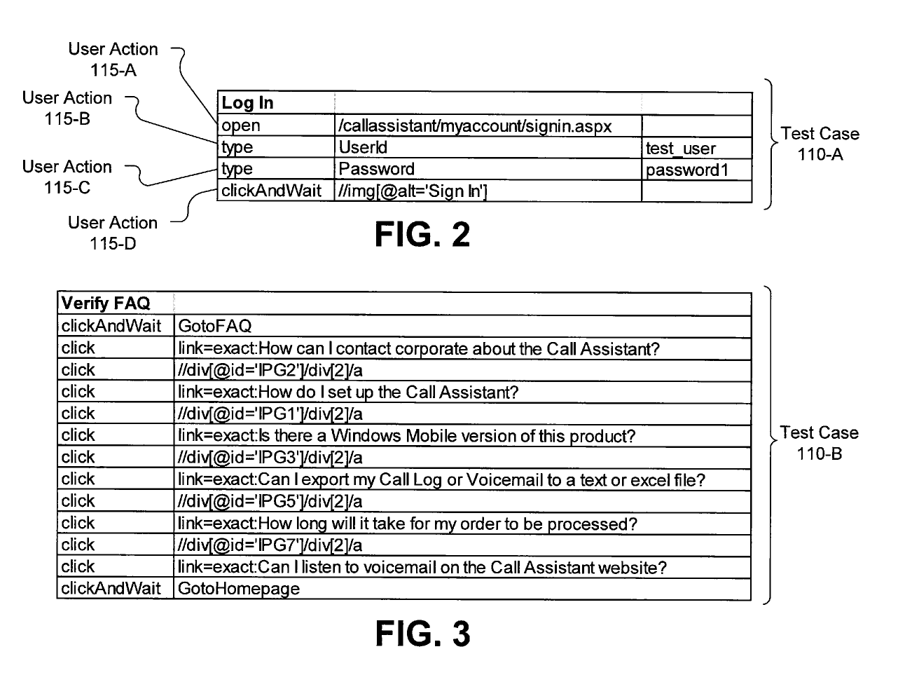

FIG. 2 illustrates an exemplary test case 110-A for the initial setup of an application under test 105. As shown, the exemplary test case 110-A includes four ordered user actions 115 that when simulated provide for logging into an application under test 105. User action 115-A indicates a URL of an application under test 105 to be opened in a browser. Then user action 115-B indicates a username to be typed into the “UserId” field of the application under test 105. Then, user action 115-C indicates a password to be typed into the “Password” field of the application under test 105. Then user action 115-D indicates that a “Sign In” button to be clicked on, and that the test case 110-A should wait for a new page of the application under test 105 to load once the “Sign In” button is pressed. While the test case 110-A includes four user actions 115, test cases 110 of different lengths and compositions may be utilized as well. Moreover, while the test case 110-A illustrated in the Figure is written in the Selenese language of the Selenium web application testing system (available at http://seleniumhq.org), other languages may be utilized for test cases 110 as well.

FIG. 3 illustrates an exemplary test case 110-B for the testing of a portion of functionality of an application under test 105. The exemplary test case 110-B assumes that the application under test 105 is in a logged in state, such as after the execution of the test case 110-A discussed above with regard to FIG. 2. Based on the known initial state, the test case 110-B includes a first user action 115 that causes the application under test 105 to be navigated to a frequently asked questions page of the application under test 105. Then the test case 110-B includes multiple user actions 115 that click several links on the frequently asked questions page. Finally, the test case 110 navigates back to the homepage of the application under test 105, returning the application under test 105 back to the known state for further tests cases 110.

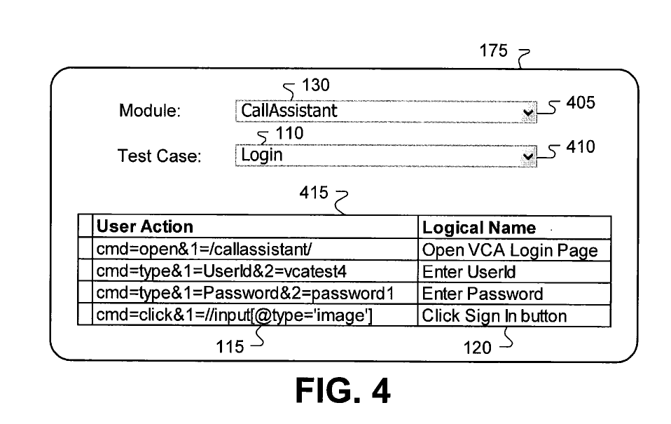

FIG. 4 illustrates an exemplary user interface 175 for the mapping of logical names 120 to the recorded user actions 115 of a selected test case 110 in a module 130.

The user interface 175 may include a modules list 405 interface element configured to list the modules 130 available in the repository 140, and provide for the selection of one of the modules 130. The user interface 175 may further include a test list 410 interface element populated with a list of the test cases 110 included in the selected module 130, where the test list 410 interface element may further be configured to provide for selection of one of the test cases 110.

The user interface 175 may include a grid 415 interface element configured to be populated with a list of user actions 115 for the test case 110 in the selected module 130. The grid 415 may further include a column of associated logical names 120 that may be mapped to each of the listed user actions 115. As shown, the user actions 115 are included in a first column and the associated logical names 120 are included in a second column. The grid 415 may be configured to allow the user to add, remove, and edit the logical names 120 associated with each of the user actions 115.

For example, a “Login” test case 110 in the “CallAssistant” module 130 may be selected through use of modules list 405 interface element and test list 410 interface element, and the grid 415 interface elements accordingly may include the user actions 115 for the selected “Login” test case 110. Additionally, for each user action 115 of the “Login” test case 110, a mapped logical name 120 may be input and displayed to explain the functionality of the associated user action 115.

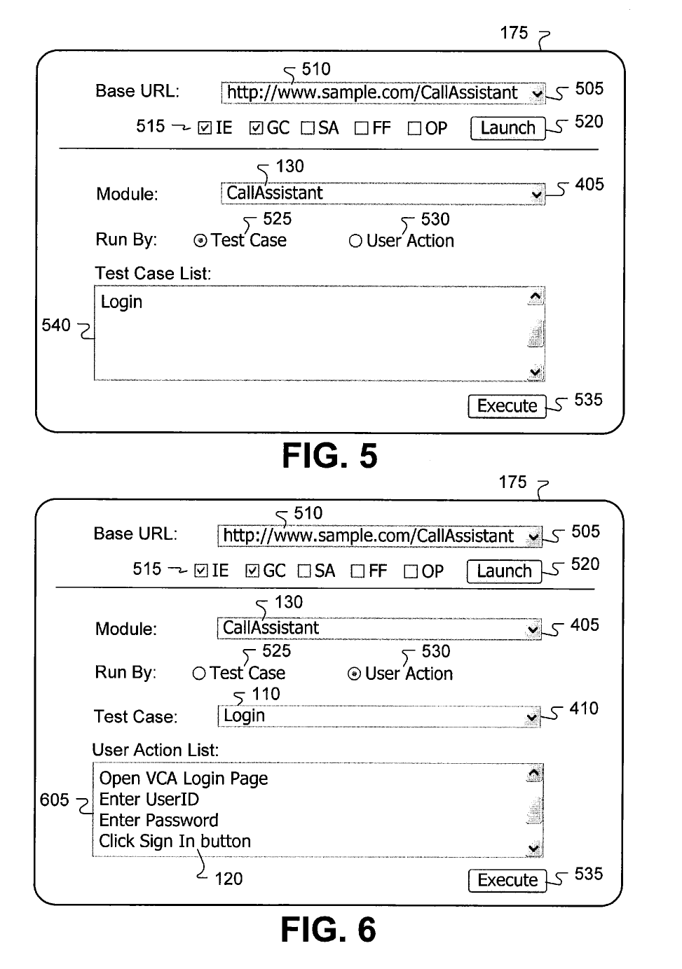

FIG. 5 illustrates exemplary aspects of a user interface 175 for the selection of test cases 110 for simulation by the simulator 155. A user may select a project 135, and based on the selected project 135, the user may further determine one or more test cases 110 and/or user actions 120 within one or more modules 130 to execute.

As illustrated in FIG. 5, the user interface 175 may include a URL selector 505 interface element providing for the selection or input of a base URL 510 at which to begin the test. The base URL 510 may indicate a location at which to being the testing of an application under test 105. For example, the base URL 510 may indicate a main page of an application under test 105, or may indicate a login page of an application under test 105 that is to be visited first. It may be desirable to select a base URL 510 because a development system may include multiple similar versions of the same application under test 105, and it may be useful to be able to run the same tests against the different versions. The base URL 510 may be selected from the URL selector 505 dropdown list control including URLs of various applications under test 105, or may be entered by a user directly, such as by way of a user input device. In some examples, the listed base URLs 510 may be defined based on base URLs associated with the selected project 135.

The user interface 175 may further provide one or more environment selector 515 interface elements for the selection of one or more test environments 145 in which to execute the test. For example, environment selectors 515 may be included to allow for the selection of one or more of Internet Explorer™ (IE), Google® Chrome™ (GC), Safari® (SA), Firefox® (FF), and Opera® (OP) test environments 145. As another example, environment selectors 515 may be included to allow for the selection of one or more operating systems, such as Microsoft® Windows®, Mac OS X®, Linux®, etc.

The user interface 175 may further include a launch 520 interface element configured to initiate each of the selected test environments 145 and make them available for the simulation of test cases 110 and/or user actions 115. In some instances, the launch 520 interface element may be implemented as a button that when pressed causes the simulator 155 to launch browsers in the selected test environments 145 and navigate each launched browsers to the specified base URL 510.

The user interface 175 may further provide for selection of tests according to test case 110 and user action 115. Similar to as discussed above, the user interface 175 may include a modules list 405 interface element to provide for the selection of a module 130 from which test cases 110 or user actions 115 to be executed may be chosen.

The user interface 175 may further include by test case 525 and by user action 530 interface elements allowing for selection of a test according to test case 110 or user action 115, respectively. If the user selects to choose a test according to test case 110, a test case list 540 interface element may be populated with a list of test cases 110 within the chosen module 130 as shown in FIG. 5. Selection of a test according to user action 115 is discussed in detail with respect to FIG. 6.

Continuing with FIG. 5, the test case list 540 interface element may be populated with a list of the test cases 110 included in the selected module 130, where the test case list 540 is configured to provide for selection of one or more test cases 110.

The user interface may further include an execute 535 interface element configured to provide for execution of the selected one or more test cases 110. The execute 535 interface element may be enabled when at least one test case 110 in the test case list 540 is selected to be run. When the execute 535 interface element is selected, the simulator 155 may receive a message from the user interface 175 configured to cause the simulator 155 to retrieve the selected test cases 110 from the repository 140, and simulate the test cases 110 in each of the launched test environments 145.

For example, a user may select the Internet Explorer™ test environment 145 and the Google® Chrome™ test environment 145 for testing by way of the IE and GC environment selector 515 interface elements, and may set the base URL 510 to “http://www.sample.com/CallAssistant” by way of the URL selector 505 interface element. Upon selection of the launch 520 interface element, the simulator 155 may receive one or more messages from the user interface 175 configured to cause the simulator 155 to launch an Internet Explorer™ web browser in a first test environment 145, navigate the Internet Explorer™ browser to the specified base URL 510, launch a Google® Chrome™ web browser in a second test environment 145, and navigate the Google® Chrome™ browser to the specified base URL 510. The user may further select a “CallAssistant” module 130 using the modules list 405 interface element, and select a “Login” test case 110 from the test case list 540 interface element. The user may further select the execute 535 interface element, thereby causing the simulator 155 to retrieve the “Login” test case 110 from the repository 140, and execute it in the launched Internet Explorer™ and Google® Chrome™ test environments 145.

FIG. 6 illustrate exemplary aspects of a user interface 175 for the selection of user actions 115 for simulation by the simulator 155. As indicated above with respect to FIG. 5, the user interface 175 may provide by test case 525 and by user action 530 interface elements allowing for selection of a test according to test case 110 or user action 115. In FIG. 5 the by test case 525 interface element is selected to provide for the selection of a test by test case 110. However, in FIG. 6, the by user action 530 interface element is selected to provide for the selection of a test by user action 115.

As shown in FIG. 6, the user interface 175 may include a test list 410 interface element providing for the selection of one of a list of test cases 110 for the module 130 selected from the modules list 405 interface element. Upon selection of a test case 110, a user action list 605 interface element may be populated with a list of the user actions 115 included in the selected test case 110. These user actions 115 may be represented according to logical names 120 rather than the user action 115 code to increase readability of the displayed list. It should be noted that in other instances, the user actions 115 code may be included in the list directly rather than the logical names 120.

The user interface may further include an execute 535 interface element. Similar as described about with respect to FIG. 5, the user interface 175 shown in FIG. 6 may also include an execute 535 interface element, but in this instance providing for the execution of the selected user actions 115 rather than entire test cases 110. The execute 535 interface element may be enabled when at least one user action 115 in the user action list 605 interface element is selected to be run. When the execute 535 interface element is selected, the simulator 155 may receive one or more messages from the user interface 175 configured to cause the simulator 155 to retrieve the selected user action 115 from the repository 140, and simulate the user action 115 in each of the launched test environments 145.

For example, a user may select a “Login” test case 110 in a “CallAssistant” module 130 is selected by way of the modules list 405 interface element and the test list 410 interface element. Accordingly, the user action list 605 interface element may be populated with logical names 120 of the user actions 115 of the “Login” test case 110. Specifically, the “Login” test case includes an “Open VCA Login Page” user action 115, an “Enter UserID” user action 115, an “Enter Password” user action, and a “Click Sign In button” user action 115. Once user selects at least one of the user actions 115 from the user action list 605 interface element, the execute 535 interface element may be selected, thereby causing the simulator 155 to retrieve the selected user actions 115 from the repository 140, and execute them in the launched Internet Explorer™ test environment 145 and Google® Chrome™ test environment 145.

Provided that the test environments 145 remain running, multiple tests may be selected and simulated against an application under test 105 while reusing the same test environments 145. Because the simulator 155 may keep track of the session identifiers 160 of the launched test environments 145 for each user, the simulator 155 may allow for the same test environments 145 to be utilized by the user for additionally selected tests. As an example, a user may first select test case 110-A as shown in FIG. 2 to be simulated, and once test case 110-A completes the user may then select test case 110-B as shown in FIG. 3 to be simulated. As another example, test case 110-B may be selected to be repeated additional times, or yet another test case 110 or user action 115 may be simulated after test case 110-B. Alternately, if no test environments 145 have been launched or remain running, execution of the selected test cases 110 or user actions 115 may fail.

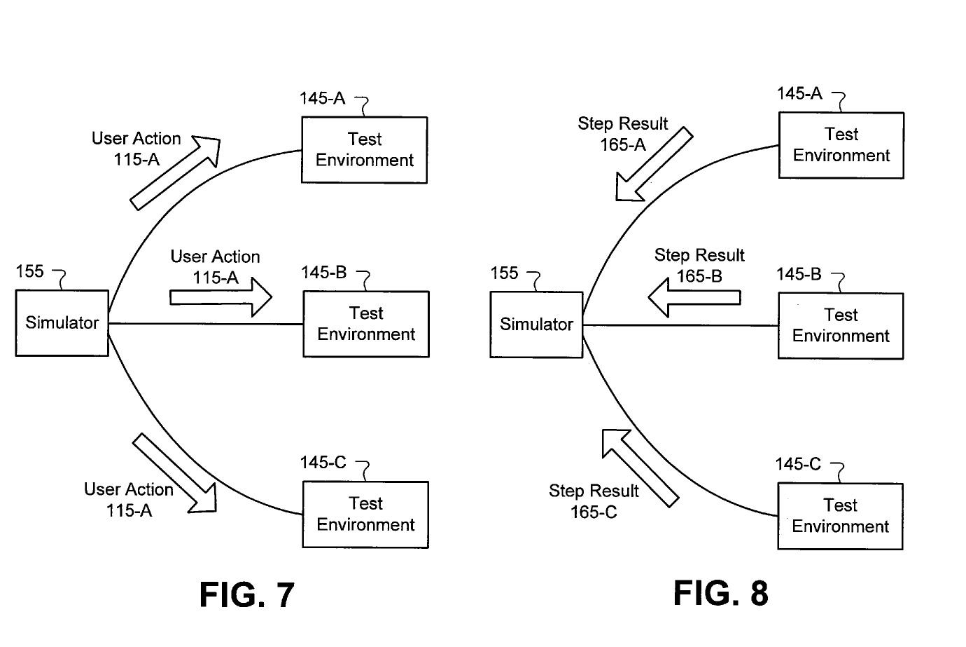

FIG. 7 illustrates an exemplary system view of the execution of a single user action 115-A sent from a simulator 155 to multiple test environments 145-A, 145-B and 145-C. The user interface 175 may indicate for the parser 180 to send a message to the simulator 155 configured to cause the simulator 155 to launch one or more test environments 145. The simulator 155 may accordingly receive session identifiers 160 corresponding to the launched test environments 145. The user interface 175 may further send a message to the simulator 155 configured to cause the simulator 155 to retrieve an indicated test case 110 or user action 115 from the repository 140 and simulate the indicated test case 110 or user action 115 in the launched test environments 145. The test environments 145 to use may be identified to the simulator 155 according to session identifier 160 and/or network identifier.

As shown, the simulator 155 is simulating a selected user action 115-A from the test case 110-A illustrated in FIG. 2 in each of three test environments 145-A, 145-B and 145-C.

As discussed above, the simulator 155 may include a controller portion outside the test environment 145, and an agent part inside of each of the test environments 145. The controller portion of the simulator 155 may send the user action 115-A to the agent, and the agent may execute the user actions 115 against the application under test 105. Each of the test environments 145-A, 145-B, and 145-C may accordingly receives the same user action 115-A for execution from the simulator 155 by respective agents running in each of the test environments 145-A, 145-B, and 145-C.

The configurations of the test environments 145 may be specified by the simulator 155 to correspond with the scenarios being tested for the application under test 105. As an example, test environment 145-A may be configured to include the Firefox® web browser application installed on Microsoft Windows, test environment 145-B may be configured to include the Internet Explorer™ browser application on Microsoft® Windows®, and test environment 145-B may be configured to include the Google® Chrome™ browser application on Microsoft Windows. Such a set of test environments 145 may allow for a user to verify that an application under test 105 properly functions on different web browsers running on the same operating system.

FIG. 8 illustrates an exemplary system view of the logging of an executed single user action 115-A by the multiple test environments 145-A, 145-B and 145-C. For each of the test environments 145-A, 145-B and 145-C, a corresponding step result 165-A, 165-B and 165-C may be returned to the simulator 155 from the respective agents running within test environments 145-A, 145-B, and 145-C.

The step result 165-A may be indicative of the result of the execution of the user action 115-A by the test environment 145-A, the step result 165-B may be indicative of the result of the execution of the user action 115-A by the test environment 145-B, and the step result 165-C may be indicative of the result of the execution of the user action 115-A by the test environment 145-C.

In some examples, once a step result 165 is returned back to the simulator 155 from a test environment 145, the next user action 115 may then be sent to the test environment 145 for simulation. However in other examples, the simulator 155 will not send the next user action 115 to the test environments 145 until step results 165 for a user action 115 are received from each of the test environments 145. This delayed approach may be desirable in order to keep each of the test environments 145-A, 145-B, and 145-C synchronized.

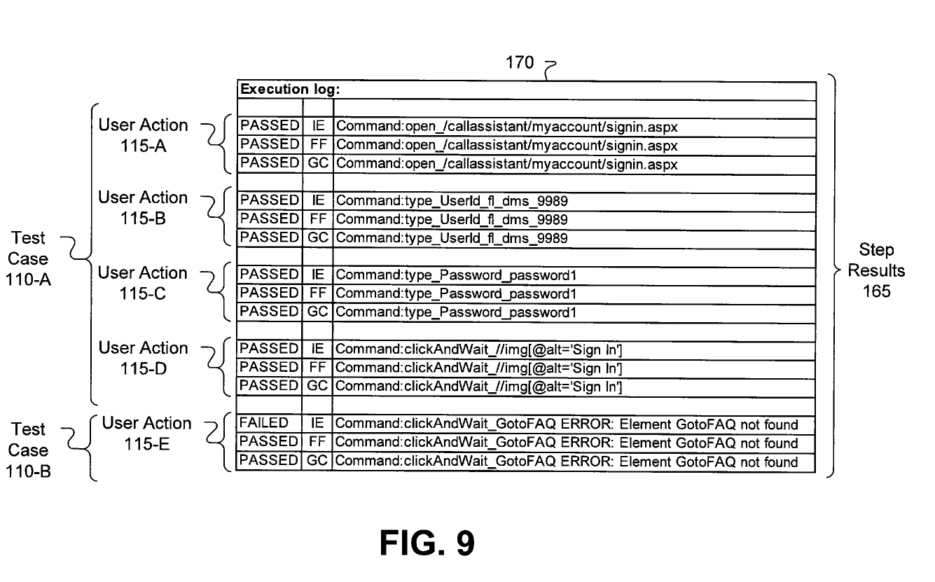

FIG. 9 illustrates an exemplary execution log file 170 including step results 165 from the simulation of the user actions 115-A through 115-E of the test cases 110-A and 110-B. The log file 170 may be configured to group together the one or more step results 165 for the execution of each user action 115, so that compatibility issues with one or more of test environment 145 may be more readily discernable.

As shown in the Figure, user actions 115-A, 115-B, 115-C, and 115-D of test case 110-A were each successfully simulated by test environments 145-A, 145-B, and 145-C. Accordingly, the test case 110-A passed compatibility testing across the three test environments 145-A, 145-B, and 145-C. However, user action 115-E of test case 110-B failed execution in one of the test environments 145.

In the example, due to the failure of test case 110-B, the next user action 115 of test case 110-B was not executed and does not appear in the log. Rather, because the test environments 145 could no longer remain synchronized due to the failure, execution of the test cases 110 was terminated. In other examples, however, execution of the test cases 110 may be attempted, or at least execution of the test cases 110 that continue without failures may be continued.

A user of the system may accordingly view the log file 170, and may therefore determine from the log any potential compatibility issues with the application under test 105 across various test environments 145. The system may further provide a report delivered to a user, where the report may indicate whether the tests passed or failed for each test environment 145. This information may be utilized to debug and improve the proper functioning of the application under test 105.

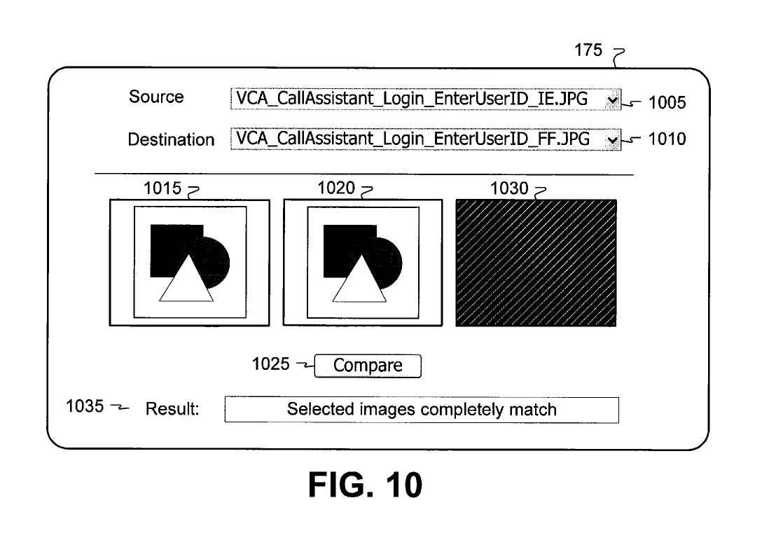

FIG. 10 illustrates an exemplary user interface 175 for the analysis of a failure in the log file 170. As discussed above, the simulator 155 may provide step results 165 regarding the result of the simulated user actions 115, where these step results 165 may include a screen capture of the application under test 105 after the execution of the user action 115. When reviewing the log file 170, the user interface 175 may include a source screen capture 1005 interface element and a destination screen capture 1010 interface element.

The source screen capture 1005 interface element may be configured to allow for selection of a saved screenshot from a step result 165 included in a log file 170. The destination screen capture 1010 interface element may be configured to allow for selection of a second saved screenshot from a step result 165 included in a log file 170. The source screen capture 1005 and destination screen capture 1010 may then be displayed in the user interface 175 in a source image 1015 interface element and a destination image 1020 interface element, respectively.

In some instances differences between screenshots may be readily discernable; however in other cases the differences may be more subtle. Accordingly, the user interface 175 may further include a compare 1025 interface element that when selected is configured to cause the user interface 175 to determine and display a difference image 1030 including the differences between the image shown in the source image 1015 interface element and the destination image 1020 interface element. Additionally, the user interface 175 may also include a textual indication 1035 interface element configured to illustrate of whether the images displayed in the source image 1015 interface element and destination image 1020 interface element differ. For example, the textual indication 1035 interface element may indicate that the images match, or that the images do not match.

As shown in FIG. 10, a source image 1015 interface element may show a screenshot included in a step result 165 logged from an Internet Explorer™ test environment 145 compared against a screenshot shown in a destination image 1030 interface element including a step results 165 logged from a Firefox® test environment 145. Upon selection of the compare 1025 interface element, the user interface 175 may determined that the screenshots match. Accordingly, this status may be reflected in the user interface 175 by way of the textual indication 1035 interface element.

Through comparison of screen captures of the application under test 105 after the execution of the user action 115, a user may be able to easily determine cross compatibility of an application under test 105 across multiple test environments 145.

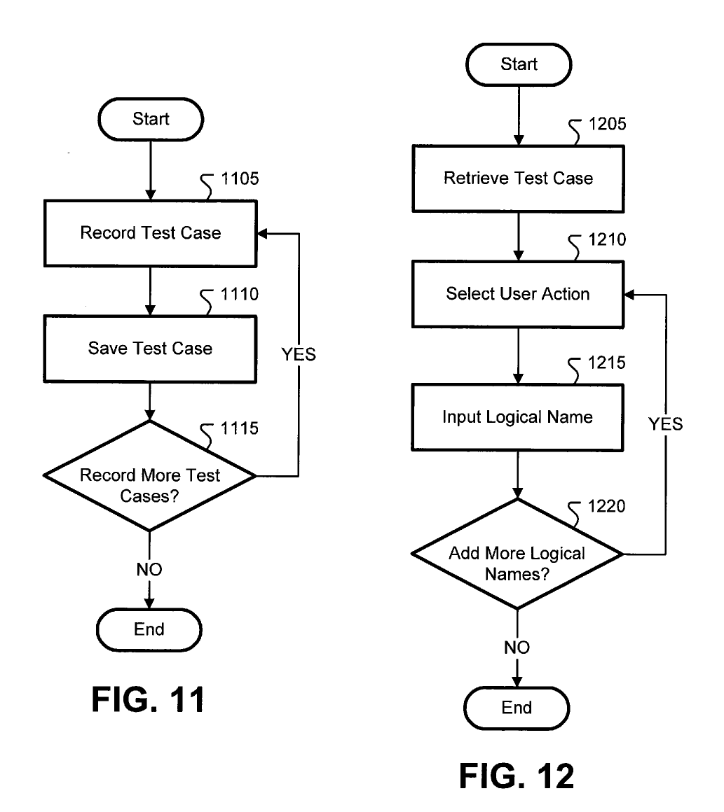

FIG. 11 illustrates an exemplary process flow 1100 for the creation of test cases 110. The process 1100 may be performed by various systems, such as the system 100 described above with respect to FIG. 1.

In block 1105, the system 100 records a test case 110. The system 100 may include a recorder 150 in selective communication with a test environment 145 in which an application under test 105 is run. Upon selection of a record control in a user interface 175 of the system 100, the recorder 150 may record user actions 115 according to the interactions of a user with the application under test 105. For example, a user may navigate to a login page of a web application under test 105, enter a username into a username field of the application, enter a password into a password field of the application, press a login button, and navigate through pages of the application under test.

In block 1110, the system 100 saves the test case 110. For example, the recorder 150 may be in selective communication with a repository 140, and may send the test case 110 recorded against the application under test 105 to the repository 140 for storage.

In decision point 1115, the system 100 receives an indication whether the recorder 150 should record additional test cases 110. For example, the user interface 175 of the system 100 may receive an indication from the user whether the recorder 150 should record additional test cases 110. If it is determined that more test cases 110 should be recorded, block 1105 is executed next. Otherwise, the process 1100 ends.

FIG. 12 illustrates an exemplary process flow 1200 for the mapping of logical names 120 to the user actions 115 of a stored test case 110. As with process 1100 discussed above with regard to FIG. 11, process 1200 may be performed by various systems, such as the system 100 described above with respect to FIG. 1.

In block 1205, the system 100 retrieves a test case 110. For example, a user may utilize a user interface 175 such as illustrated in FIG. 4 to select a module 130 and to further select a test case 110 included in the module 130. Upon selection of the test case 110, the user interface 175 may send a message to the parser 180 configured to cause the parser 180 to retrieve the test case 110 from the repository 140 and forward the test case 110 on to the user interface 175.

In block 1210, the system 100 receives a selection of a user action 115. For example, upon receipt of the selected test case 110, the user interface 175 may populate a grid 415 with the user actions 115 of the selected test case 110.

In block 1215, the system 100 receives an input logical name 120. For example, the grid 415 may further be configured to include a column of associated logical names 120 that may be mapped to each of the listed user actions 115 and to allow the user to add, remove, and edit the logical names 120.

In decision point 1220, the system determines whether to map more logical names 120 to user actions 115. If it is determined that more logical names 120 are to be mapped, block 1210 is executed next. Otherwise, the process 1200 ends.

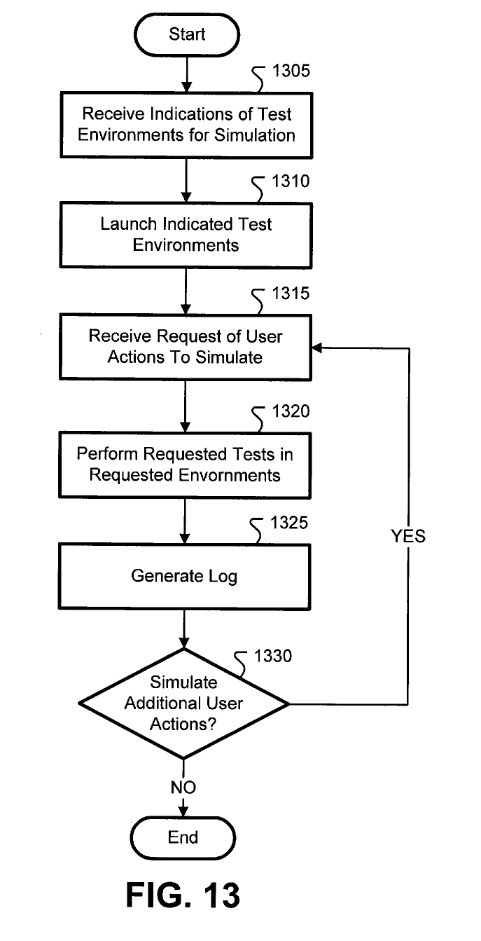

FIG. 13 illustrates an exemplary process flow 1300 for the execution of test cases 110. As with processes 1100 and 1200 discussed above, process 1300 may be performed by various systems, such as the system 100 described above with respect to FIG. 1.

In block 1305, the system 100 receives indications of test environments 145 for simulation by the system 100. For example, as illustrated in FIGS. 5 and 6, the user interface 175 may provide by way of a URL selector 505 interface element for the selection of a base URL 510 at which to begin the test and also through use of environment selector 515 interface elements for the selection of one or more of a test environments 145 in which to execute the test. In some examples, at least a portion of the base URLs 510 may be included in the URL selector 505 according to the base URLs associated with a selected project 135 corresponding to the application under test 105.

In block 1310, the system 100 launches the indicated test environments 145. For example, the user interface may include a launch 520 interface element that when pressed may initiate each of the selected test environments 145 and make them available for the simulation of test cases 110 and/or user actions 115. Upon selection of a launch 520 interface element, the simulator 155 may launch browsers in the selected test environments 145 and may navigate each launched browsers to the specified base URL 510. The simulator 155 may receive and maintain session identifiers 160 and/or network identifiers corresponding to the test environments 145 launched by the user.

In block 1315, the system 100 receives a request of user actions 115 to simulate. For example, the user interface 175 may further provide a modules list 405 interface element from which a module 130 may be selected, and a by test case 525 interface element allowing for selection of a test according to test case 110 as well as a test case list 540 interface element from which to select one or more test cases 110. The user interface 175 may further provide a test list 410 interface element for the selection of a test case 110 to execute, and a user action list 605 interface element for the selection of one or more user actions 115 included in a selected test case 110.

In block 1320, the system 100 performs the requested test cases 110 or user actions 115 in the requested test environments 145. For example, the simulator 155 may receive one or more messages from the user interface 155 configured to cause the simulator 155 to retrieve the selected test case 110 from the repository 140, and simulate the test case 110 in each of the launched test environments 145. The launched test environments 145 may be identified according to session identifiers 160 and/or network identifiers corresponding to the test environments 145 launched by the user above in block 1310.

In block 1325, the system 100 generates a log file 170 based on the performed user actions 115. For example, for each of the test environments 145, corresponding step results 165 indicative of the results of the execution of the user action 115 may be returned to the simulator 155. In some instances, the step results 165 may include a screen capture of the application under test 105 after the execution of the user action 115. The step results 165 may be stored on the repository 140. The user may view and analyze the generated log to determine whether the application under test 105 is cross compatible with the launched test environments 145.

In decision point 1330, the system 100 determines whether or not to simulate additional user action 115. If it is determined that additional user action 115 are to be simulated, block 1315 is executed next. Otherwise, the process 1300 ends.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a plurality of test environments, each said test environment being configured to simulate user actions according to a test configuration; and
a test simulator device including a processor in selective communication with said plurality of test environments and configured to:
receive a user action;
send said user action to a first of said plurality of test environments having a first test environment; and
send said user action to a second of said plurality of test environments having a second test environment.

2. The system of claim 1, wherein each of said first and second test environments includes an operating system version and a web browser version, and said first and second test environments differ by at least one of operating system version and web browser version.

3. The system of claim 1, wherein said test simulator device is further configured to send commands to each of said first and second test environments, said commands being configured to cause said first and second test environments each to execute said user action at substantially the same time.

4. The system of claim 1, wherein said test simulator is further configured to:
receive a request to launch a first test environment and a second test environment;
launch said first test environment and a second test environment according to said launch request;
receive from said first test environment a first session identifier indicative of said first test environment; and
receive from said second test environment a second session identifier indicative of said second test environment.

5. The system of claim 5, wherein said test simulator is further configured to:
send said user action to said first of said plurality of test environments according to said first session identifier; and
send said user action to said second of said plurality of test environments according to said second session identifier.

6. The system of claim 1, wherein said test simulator device is further configured to receive test result data from said first and second test environments.

7. The system of claim 6, wherein said test simulator device is further configured to analyze said test result data from said first and second test environments to determine differences in execution of said test case between said first and second test environments.

8. The system of claim 6, wherein said test simulator device is further configured to send said test result data to a database in selective communication with said test simulator device.

9. The system of claim 1, further comprising a database in selective communication with said test simulator device, wherein said database is configured to selectively retrieve said user action from a plurality of stored user actions upon receipt of a request from said test simulator device.

10. The system of claim 1, further comprising a user interface in selective communication with said test simulator and configured to:
display a plurality of user actions according to logical name;
receive a selection of said user action from said plurality of displayed user actions; and
send an indication of said selected user action to said test simulator for simulation.

11. The system of claim 1, further comprising a user interface in selective communication with said test simulator and configured to:
receive a selection of a test case;
display a user action included in said test case;
receive a logical name for said displayed user action; and
associate said logical name with said displayed user action.

12. A method, comprising:
receiving a test case including at least one recorded user action at a test simulator device including a processor;
sending, from the test simulator device, a first user action included in the test case to a first test environment running an application under test and to a second test environment running the application under test;
receiving a first result indicating that said first user action was simulated on the application under test by said first test environment;
receiving a second result indicating that said first user action was simulated on the application under test by said second test environment; and
sending a second user action included in the test case to the first and second test environments upon receiving both the first and the second results.

13. The method of claim 12, wherein the first result and the second result are each step results indicative of the result of execution of the first user action on the application under test by the associated test environment.

14. The method of claim 13, wherein each step result comprises a screen capture of the application under test after the execution of the first user action.

15. The method of claim 14, further comprising comparing the screen capture of the application under test after execution of the first user action in the first test environment with the screen capture of the application under test after execution of the first user action in the second test environment.

16. The method of claim 12, further comprising analyzing the first result and the second result to determine differences in execution of the test case between said first and second test environments.

17. The method of claim 12, further comprising receiving an indication of a plurality of test environments on which to simulate the test case.

18. The method of claim 12, further comprising:
sending the user action to the first of the plurality of test environments according to a first session identifier associated with the first of the plurality of test environments; and
sending the user action to the second of the plurality of test environments according to a second session identifier associated with the second of the plurality of test environments.

19. The method of claim 18, further comprising:
receiving a request to launch the first test environment and the second test environment;
launching the first test environment and the second test environment according to the launch request;
receiving from the first test environment the first session identifier indicative of the first test environment; and
receiving from the second test environment the second session identifier indicative of the second test environment.

20. A computer-readable medium tangibly embodying computer-executable instructions configured to cause a processor to:
receive a test case including at least one recorded user action;
send a first user action included in the test case to a first test environment running an application under test and to a second test environment running the application under test;
receive a first result indicating that the first user action was simulated on the application under test by the first test environment;
receive a second result indicating that the first user action was simulated on the application under test by the second test environment; and
send a second user action included in the test case to the first and second test environments upon receiving both the first and the second results.

21. The computer-readable medium of claim 20, wherein the first result and the second result are each step results indicative of the result of the execution of the first user action on the application under test by the associated test environment.

22. The computer-readable medium of claim 21, wherein each step result comprises a screen capture of the application under test after the execution of the first user action.

23. The computer-readable medium of claim 22, further comprising instructions configured to cause the processor to compare the screen capture of the application under test after execution of the first user action in the first test environment with the screen capture of the application under test after execution of the first user action in the second test environment.

24. The computer-readable medium of claim 22, further comprising instructions configured to cause the processor to analyze the first result and the second result to determine differences in execution of the test case between the first and second test environments.

25. The computer-readable medium of claim 22, further comprising instructions configured to cause the processor to receive an indication of a plurality of test environments on which to simulate the test case.
